(19) United States
(12) Patent Application Publication
(10) Pub. No.: US 2025/0044605 A1
(43) Pub. Date: Feb. 6, 2025

(54) OPTICAL ELEMENT DRIVING MECHANISM

(71) Applicant: TDK TAIWAN CORP., Taoyuan City (TW)

(72) Inventors: Kai-Po FAN, Taoyuan City (TW); Man-Ting LU, Taoyuan City (TW); Yi-Ho CHEN, Taoyuan City (TW)

(21) Appl. No.: 18/790,501

(22) Filed: Jul. 31, 2024

Related U.S. Application Data
(60) Provisional application No. 63/517,770, filed on Aug. 4, 2023.

(51) Int. Cl. G02B 27/64; G02B 7/09

(52) U.S. Cl. CPC G02B 27/646; G02B 7/09

(57) ABSTRACT

An optical element driving mechanism is provided, which includes a movable assembly, a fixed portion, and a driving assembly. The movable assembly is used for connecting an optical element. The movable assembly is movable relative to the fixed portion. The driving assembly is used for driving the movable assembly to move relative to the fixed portion.

### CROSS REFERENCE TO RELATED APPLICATIONS

This Application claims priority of U.S. Provisional Patent Application No. 63/517,770 filed on Aug. 4, 2023, the entirety of which is incorporated by reference herein.

### BACKGROUND OF THE INVENTION

### Field of the Invention

The present disclosure relates to an optical element driving mechanism.

### Description of the Related Art

As technology has developed, it has become more common to include image-capturing and video-recording functions into many types of modern electronic devices, such as smartphones and digital cameras. These electronic devices are used more and more often, and new models have been developed that are convenient, thin, and lightweight, offering more choice to consumers.

Electronic devices that have image-capturing or video-recording functions normally include a driving mechanism to drive an optical element (such as a lens) to move along its optical axis, thereby achieving auto focus (AF) or optical image stabilization (OIS). Light may pass through the optical element and may form an image on an optical sensor. However, the trend in modern mobile devices is to have a smaller size and a higher durability. As a result, how to effectively reduce the size of the optical system and how to increase its durability has become an important issue.

### BRIEF SUMMARY OF THE INVENTION

An optical element driving mechanism is provided, which includes a movable assembly, a fixed portion, and a driving assembly. The movable assembly is used for connecting an optical element. The movable assembly is movable relative to the fixed portion. The driving assembly is used for driving the movable assembly to move relative to the fixed portion.

In some embodiments, the optical element driving mechanism further includes a connecting assembly, wherein: the movable assembly includes a first movable portion and a second movable portion, wherein the second movable portion is movably connected to the fixed portion and the first movable portion. The fixed portion includes a case and a bottom, and the movable assembly is disposed between the case and the bottom. The case and the bottom are arranged along a main axis. The main axis extends in a direction parallel to a first axis.

In some embodiments, the optical element driving mechanism further includes a connecting assembly disposed between the bottom and the second movable portion used for connecting the bottom and the second movable portion. The connecting assembly includes a first connecting element disposed on the second movable portion, a second connecting element disposed on the second movable portion, a third connecting element disposed on the second movable portion, and a fourth connecting element disposed in an accommodating space between the second movable portion and the bottom.

In some embodiments, the first connecting element, the second connecting element, and the third connecting element are located on a first virtual plane. The fourth connecting element is not located on the first virtual plane. A normal vector of the first virtual plane is parallel to the first axis. Materials of the first connecting element, the second connecting element, the third connecting element, and the fourth connecting element include ceramic. The fourth connecting element has a first height in the first axis. The accommodating space has a second height in the first axis. The first height is less than the second height.

In some embodiments, the second movable portion includes a main body, a first strengthen element disposed in the main body, a second strengthen element disposed in the main body, and a third strengthen element disposed in the main body. The first strengthen element, the second strengthen element, and the third strengthen element are separated from each other. Materials of the first strengthen element, the second strengthen element, and the third strengthen element includes metal. The first strengthen element, the second strengthen element, and the third strengthen element are magnetic permeable.

In some embodiments, the first strengthen element is at least partially exposed from the main body. The second strengthen element is at least partially exposed from the main body. The third strengthen element is at least partially exposed from the main body. The first strengthen element includes a first surface facing away from the driving assembly. The second strengthen element includes a second surface facing away from the driving assembly. The third strengthen element includes a third surface facing away from the driving assembly. The first surface, the second surface, and the third surface face different directions. A normal vector of the second surface is parallel to the first axis.

In some embodiments, the connecting assembly includes a first connecting portion, a second connecting portion, a third connecting portion, and a fourth strengthen element. The first connecting element is disposed between the first connecting portion and the second movable portion. The second connecting element is disposed between the second connecting portion and the second movable portion. The third connecting element is disposed between the third connecting portion and the second movable portion. The fourth connecting element is in direct contact with the bottom and the second movable portion.

In some embodiments, the fourth strengthen element passes through the first connecting portion, the second connecting portion, and the third connecting portion. The fourth strengthen element is at least exposed from the first connecting portion, the second connecting portion, and the third connecting portion. Material of the fourth strengthen element does not include metal.

In some embodiments, the first connecting portion includes a first recessed portion. The second connecting portion includes a second recessed portion. The third connecting portion includes a third recessed portion. The first connecting element is disposed in the first recessed portion. The second connecting element is disposed in the second recessed portion. The third connecting element is disposed in the third recessed portion.

In some embodiments, the second recessed portion and the third recessed portion are arranged in a direction parallel to a third axis when viewed along the first axis. The first recessed portion and the second recessed portion are arranged in a direction parallel to a second axis when viewed along the first axis. The first axis, the second axis, and the third axis extend in different directions.

In some embodiments, the bottom includes a fourth recessed portion. The first axis and the second axis are perpendicular. The first axis and the third axis are perpendicular. The second axis and the third axis are perpendicular. The connecting assembly further includes a fifth connecting element, a sixth connecting element, and a seventh connecting element. The fifth connecting element is disposed between the bottom and the first connecting portion. The sixth connecting element is disposed between the bottom and the second connecting portion. The seventh connecting element is disposed between the bottom and the third connecting portion.

In some embodiments, the first connecting element and the firth connecting element at least partially overlap each other in the first axis. The second connecting element and the sixth connecting element at least partially overlap each other in the first axis. The third connecting element and the seventh connecting element at least partially overlap each other in the first axis.

In some embodiments, the fifth connecting element, the sixth connecting element, and the seventh connecting element are located on a second virtual plane. The fourth connecting element is located on the fourth recessed portion. The first connecting element is not located on the second virtual plane. The fourth connecting element is between the first virtual plane and the second virtual plane. The first virtual plane and the second virtual plane are parallel.

In some embodiments, the first connecting portion further includes a fifth recessed portion. The second connecting portion further includes a sixth recessed portion. The third connecting portion further includes a seventh recessed portion. The fifth connecting element is disposed in the first recessed portion. The sixth connecting element is disposed in the sixth recessed portion. The seventh connecting element is disposed in the seventh recessed portion.

In some embodiments, the first recessed portion includes a first recessed surface. The second recessed portion includes a second recessed surface. The third recessed portion includes a third recessed surface. The fourth recessed portion includes a fourth recessed surface. The fifth recessed portion includes a fifth recessed surface. The sixth recessed portion includes a sixth recessed surface. The seventh recessed portion includes a seventh recessed surface. The first recessed surface and the fifth recessed surface face opposite directions. The second recessed surface and the sixth recessed surface face opposite directions. The third recessed surface and the seventh recessed surface face opposite directions. The first recessed surface, the second recessed surface, the third recessed surface, and the fourth recessed surface face an identical direction.

In some embodiments, the first recessed surface has a first size in the second axis. The second recessed surface has a second size in the second axis. The third recessed surface has a third size in the second axis. The fourth recessed surface has a fourth size in the second axis. The first size and the second size are different. The first size and the third size are different. The first size and the fourth size are different. The third size and the fourth size are different.

In some embodiments, the first size is less than the third size. The third size is less than the fourth size.

In some embodiments, the optical element driving mechanism further includes a lubricant disposed on the first recessed portion, the second recessed portion, the third recessed portion, the fourth recessed portion, the fifth recessed portion, the sixth recessed portion, and the seventh recessed portion.

In some embodiments, the fourth strengthen element and the first connecting element at least partially overlap each other in the first axis. The fourth strengthen element and the second connecting element at least partially overlap each other in the first axis. The fourth strengthen element and the third connecting element at least partially overlap each other in the first axis. The fourth strengthen element and the fourth connecting element do not overlap each other in the first axis. The fourth strengthen element and the fifth connecting element at least partially overlap each other in the first axis. The fourth strengthen element and the sixth connecting element at least partially overlap each other in the first axis. The fourth strengthen element and the seventh connecting element at least partially overlap each other in the first axis. The fourth strengthen element and the second movable portion at least partially overlap each other in the first axis.

In some embodiments, the fourth strengthen element includes a first end and a second end. The first end is disposed on the first connecting portion at least partially exposed from the first connecting portion. The second end is disposed on the third connecting portion at least partially exposed from the third connecting portion. The first end and the second end extend in an identical direction.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1A is a schematic view of an optical element driving mechanism.

FIG. 1B is an exploded view of the optical element driving mechanism.

FIG. 1C is a top view of the optical element driving mechanism.

FIG. 2A is a cross-sectional view along a line A-A in FIG. 1C.

FIG. 2B is a cross-sectional view along a line B-B in FIG. 1C.

FIG. 2C is an enlarged view of a portion R1 in FIG. 2B.

FIG. 2D is a cross-sectional view along a line C-C in FIG. 1C.

FIG. 2E is a cross-sectional view along a line D-D in FIG. 1C.

FIG. 3A is a schematic view of some elements of the optical element driving mechanism.

FIG. 3B is an enlarged view of FIG. 3A.

FIG. 3C is an enlarged view of a second movable portion.

FIG. 3D is a schematic view of a first buffering element.

FIG. 4A is a top view of some elements of the optical element driving mechanism.

FIG. 4B and FIG. 4C are side views of some elements of the optical element driving mechanism.

FIG. 4D is a schematic view of some elements of the optical element driving mechanism.

FIG. 5A is a schematic view of a first circuit element.

FIG. 5B is a cross-sectional view of the first circuit element.

FIG. 6A, FIG. 6B, and FIG. 6C are enlarged views of the bottom viewed in different directions.

FIG. 7A, FIG. 7B, and FIG. 7C are schematic views of some elements of the optical element driving mechanism.

FIG. 8A, FIG. 8B, FIG. 8C, and FIG. 8D are schematic views of the optical element driving mechanism viewed from different directions.

### DETAILED DESCRIPTION OF THE INVENTION

The following disclosure provides many different embodiments, or examples, for implementing different features of the provided subject matter. Specific examples of elements and arrangements are described below to simplify the present disclosure. These are, of course, merely examples and are not intended to be limiting. For example, in some embodiments, the formation of a first feature over or on a second feature in the description that follows may include embodiments in which the first and second features are in direct contact, and may further include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may further include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

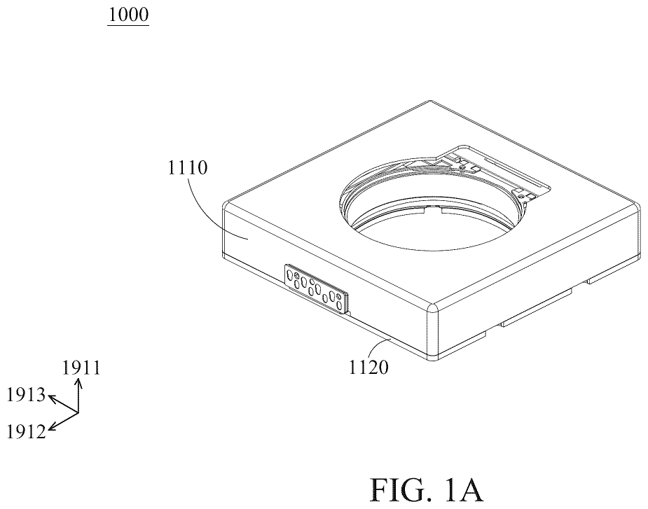

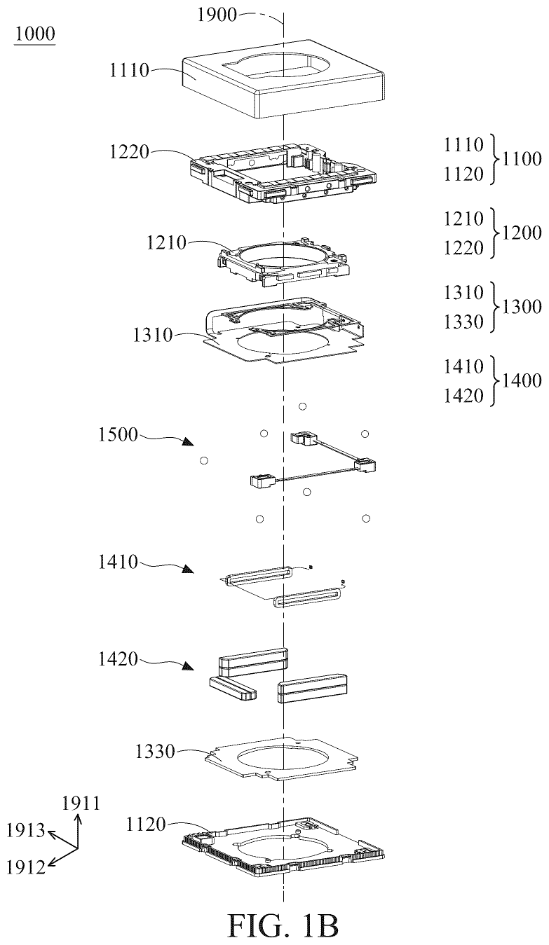

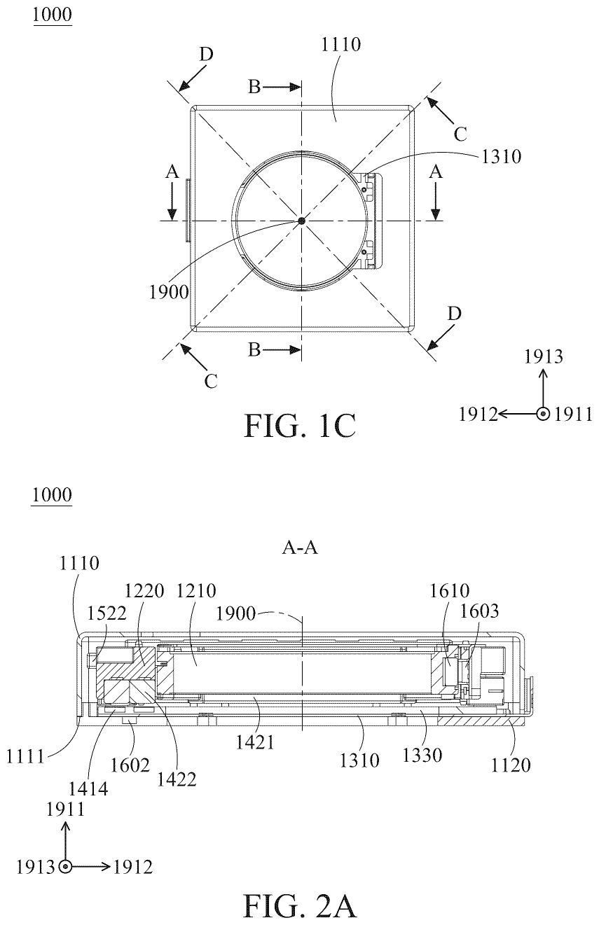

Embodiments of the present disclosure disclose an optical element driving mechanism used for driving an optical element to move. For example, FIG. 1A is a schematic view of an optical element driving mechanism 1000. FIG. 1B is an exploded view of the optical element driving mechanism 1000. FIG. 1C is a top view of the optical element driving mechanism 1000. As shown in FIG. 1A to FIG. 1C, the optical element driving mechanism 1000 may mainly include a fixed portion 1100, a movable assembly 1200, a circuit assembly 1300, a driving assembly 1400, and a connecting assembly 1500 arranged along a main axis 1900.

In some embodiments, the fixed portion 1100 may include a fixed portion 1100 and a bottom 1120, which may combined together to form a shell of the optical element driving mechanism 1000. For example, the fixed portion 1100 and the movable assembly 1200 may arrange along the main axis 1900, and other elements may be disposed in the shell to protect these elements. The movable assembly 1200 may include a first movable portion 1210 and a second movable portion 1220 movable relative to the fixed portion 1100. An optical element (not shown) may be disposed in the first movable portion 1210 to allow the optical element being driven by the optical element driving mechanism 1000 to move with the movable assembly 1200, so auto focus (AF) may be achieved.

In some embodiments, the optical element may be, for example, a lens, a mirror, a prism, a reflective polished surface, an optical coating, a beam splitter, an aperture, a liquid lens, an image sensor, a camera module, or a ranging module. It should be noted that the definition of the optical element is not limited to the element that is related to visible light, and other elements that relate to invisible light (e.g. infrared or ultraviolet) are also included in the present disclosure.

In some embodiments, the circuit assembly 1300 may include a first circuit element 1310 and a second circuit element 1330 to electrically connect to the elements in the optical element driving mechanism 1000 and other external devices, and the circuit assembly 1300 may connect to the fixed portion 1100 and the movable assembly 1200 to allow the first movable portion 1210 movably connecting to the second movable portion 1220 through the circuit assembly 1300. The second circuit element 1330 may affixed on the bottom 1120 through the first circuit element 1310 and may include printed circuit board (PCB), for example. In some embodiments, the driving assembly 1400 may include a coil assembly 1410 and a magnetic assembly 1420 and may be used for driving the movable assembly 1200 to move relative to the fixed portion 1100. In some embodiments, the connecting assembly 1500 may be used for movably connecting the fixed portion 1100 and the movable assembly 1200.

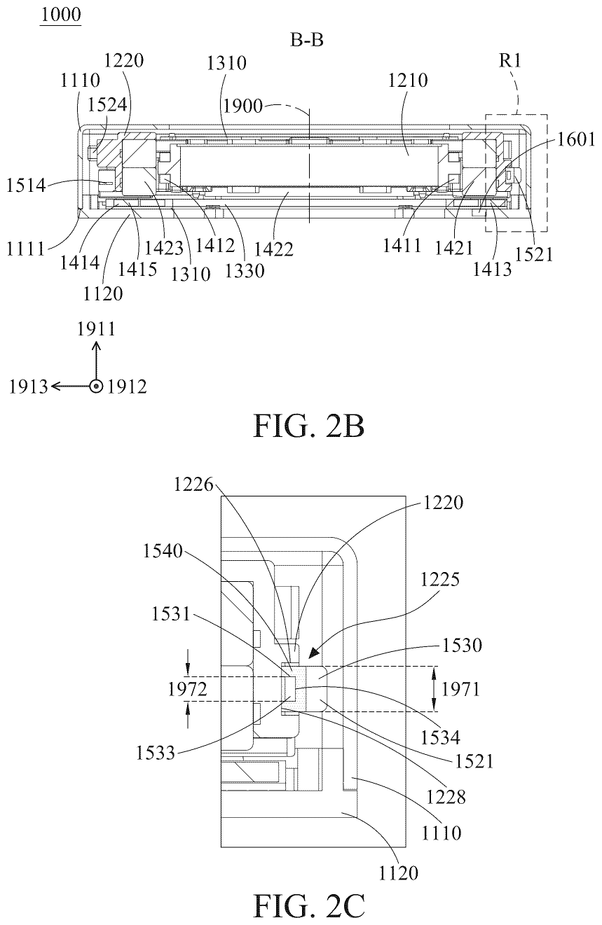

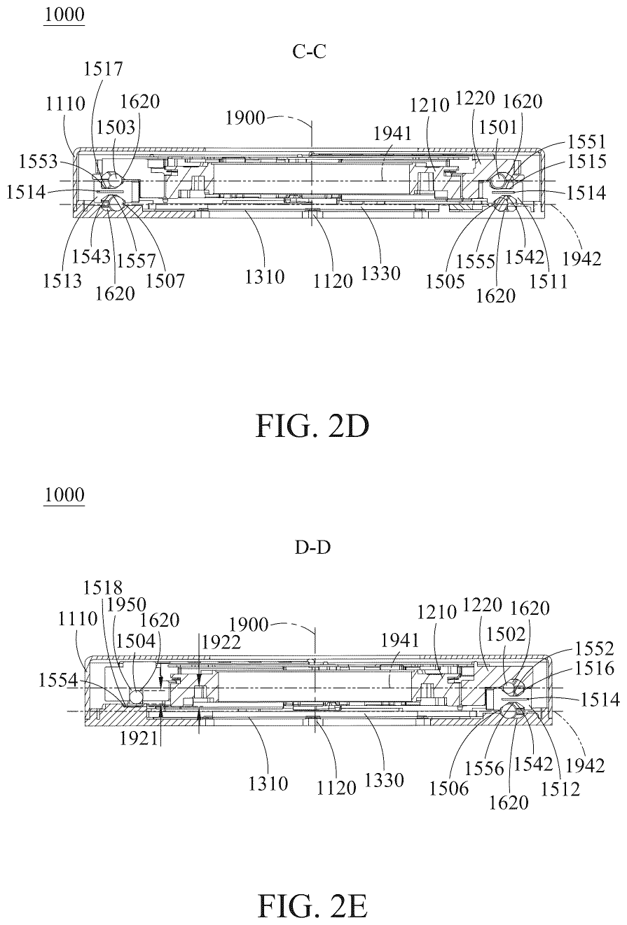

FIG. 2A is a cross-sectional view along a line A-A in FIG. 1C. FIG. 2B is a cross-sectional view along a line B-B in FIG. 1C. FIG. 2C is an enlarged view of a portion R1 in FIG. 2B. FIG. 2D is a cross-sectional view along a line C-C in FIG. 1C. FIG. 2E is a cross-sectional view along a line D-D in FIG. 1C.

As shown in FIG. 2A and FIG. 2B, the coil assembly 1410 may include a first coil element 1411, a second coil element 1412, a third coil element 1413, a fourth coil element 1414, and a fifth coil element 1415. The magnetic assembly 1420 may include a first magnetic element 1421, a second magnetic element 1422, and a third magnetic element 1423. In some embodiments, the first coil element 1411 and the second coil element 1412 may be disposed on the first movable portion 1210, and the third coil element 1413, the fourth coil element 1414, and the fifth coil element 1415 may be embedded in the second circuit element 1330. In some embodiments, the main axis 1900 may be parallel to a first axis 1911, the first coil element 1411 and the second coil element 1412 may arrange along a third axis 1913, and a second axis 1912 may be perpendicular to the first axis 1911 and the third axis 1913.

In some embodiments, the first coil element 1411 may correspond to the first magnetic element 1421, the second coil element 1412 may correspond to the third magnetic element 1423, the third coil element 1413 may correspond to the first magnetic element 1421, the fourth coil element 1414 may correspond to the third magnetic element 1423, and the fifth coil element 1415 may correspond to the second magnetic element 1422. In some embodiments, along the third axis 1913, the first magnetic element 1421 is between the second movable portion 1220 and the first coil element 1411, and the third magnetic element 1423 is between the second movable portion 1220 and the second coil element 1412. Along the first axis 1911, the first magnetic element 1421 is between the second movable portion 1220 and the third coil element 1413, the second magnetic element 1422 is between the second movable portion 1220 and the fourth coil element 1414, and the third magnetic element 1423 is between the second movable portion 1220 and the fifth coil element 1415.

Therefore, the first movable portion 1210 may be moved relative to the second movable portion 1220 by the first magnetic element 1421, the third magnetic element 1423, the first coil element 1411, and the second coil element 1412. Furthermore, the second movable portion 1220 may be moved relative to the fixed portion 1100 by the first magnetic element 1421, the second magnetic element 1422, the third magnetic element 1423, the third coil element 1413, the fourth coil element 1414, and the fifth coil element 1415. Therefore, functions such as auto focus and optical image stabilization (OIS) may be achieved.

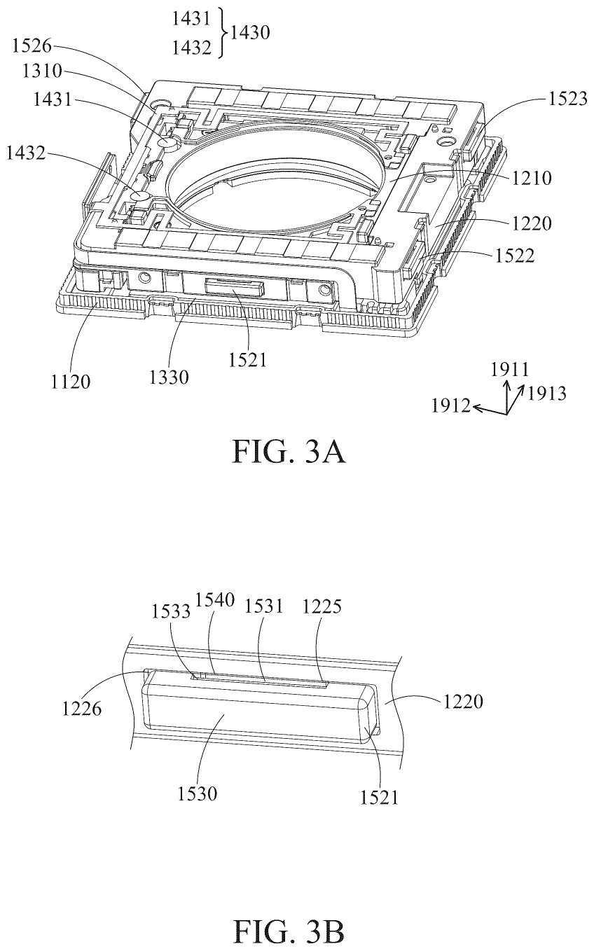

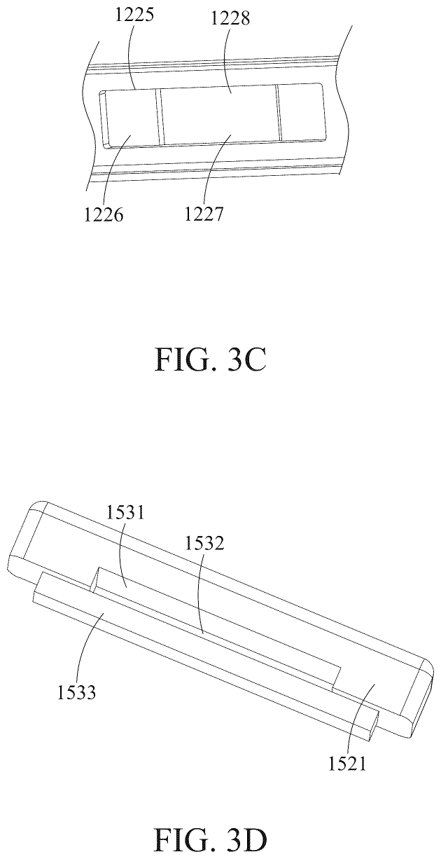

FIG. 3A is a schematic view of some elements of the optical element driving mechanism 1000. FIG. 3B is an enlarged view of FIG. 3A. FIG. 3C is an enlarged view of the second movable portion 1220. As shown in FIG. 2C, FIG. 3A, and FIG. 3B, the optical element driving mechanism 1000 may include a first buffering element 1521 disposed on the second movable portion 1220. FIG. 3D is a schematic view of the first buffering element 1521. As shown in FIG. 2C and FIG. 3D, the first buffering element 1521 may be strip-shaped and may include a main body 1530, a recessed structure 1531, a through hole 1532, and a contact portion 1533. The contact portion 1533 is connected to the main body 1530, and the recessed structure 1531 and the through hole 1532 are between the main body 1530 and the contact portion 1533. In some embodiments, as shown in FIG. 2C, along the first axis 1911, the main body 1530 has a first distance 1971, the contact portion 1533 has a second distance 1972, and the first distance 1971 and the second distance 1972 may be different. For example, the first distance 1971 may be greater than the second distance 1972.

In some embodiments, as shown in FIG. 3B, the contact portion 1533 may be in direct contact with the first disposing portion 1225 of the second movable portion 1220. In some embodiments, the first buffering element 1521 may be affixed on the first disposing portion 1225 by an adhesive element 1540. As shown in FIG. 2C and FIG. 3B, the adhesive element 1540 may be in direct contact with the recessed structure 1531 and the contact portion 1533, and the adhesive element 1540 is exposed from the first buffering element 1521 and the second movable portion 1220, such as the adhesive element 1540 may penetrate the through hole 1532. As a result, the second movable portion 1220 may be prevented from being in direct contact with the fixed portion 1100 when the second movable portion 1220 is moving relative to the fixed portion 1100 to increase the durability of the optical element driving mechanism 1000.

In some embodiments, as shown in FIG. 2C, the contact portion 1533 may include a contact surface 1534 facing away from the second movable portion 1220 and the driving assembly 1400, and the adhesive element 1540 may be in direct contact with the contact surface 1534 to increase the contact area of the first buffering element 1521 and the adhesive element 1540, so the bonding strength between the first buffering element 1521 and the adhesive element 1540 may be increased. In some embodiments, the first disposing portion 1225 may have a first disposing surface 1226 and a recessed portion 1227 recessed from the first disposing surface 1226, and a second disposing surface 1228 may be located at the recessed portion 1227. In some embodiments, the contact portion 1533 may be in direct contact with the first disposing surface 1226 and separated from the second disposing surface 1228, and the adhesive element 1540 may be disposed in the recessed portion 1227. For example, the adhesive element 1540 may be in direct contact with the second disposing surface 1228 to separate the third recessed surface 1553 from the second disposing surface 1228. In some embodiments, the movable assembly 1200 (such as the second movable portion 1220), the first buffering element 1521, and the fixed portion 1100 (such as the fixed portion 1100) may arrange along the third axis 1913, and the first buffering element 1521 may extend along the second axis 1912.

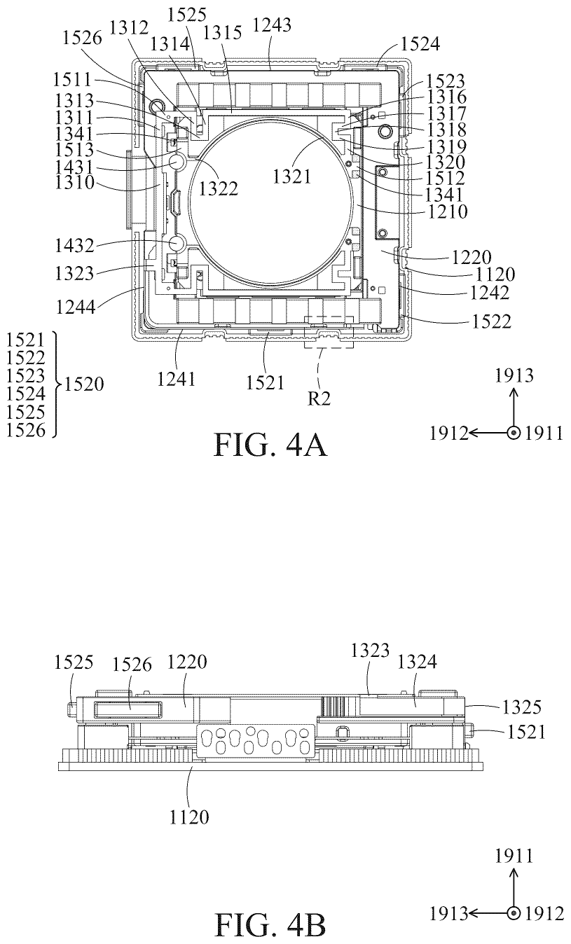

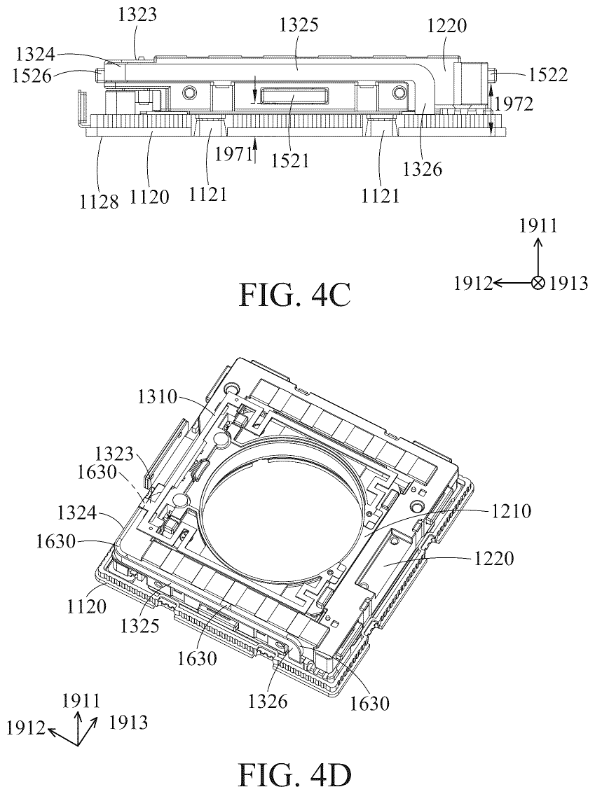

FIG. 4A is a top view of some elements of the optical element driving mechanism 1000. FIG. 4B and FIG. 4C are side views of some elements of the optical element driving mechanism 1000. FIG. 4D is a schematic view of some elements of the optical element driving mechanism 1000. As shown in FIG. 4A to FIG. 4D, besides the first buffering element 1521, the optical element driving mechanism 1000 may further include a second buffering element 1522, a third buffering element 1523, a fourth buffering element 1524, a fifth buffering element 1525, and a sixth buffering element 1526, and the first buffering element 1521, the second buffering element 1522, the third buffering element 1523, the fourth buffering element 1524, the fifth buffering element 1525, and the sixth buffering element 1526 may be called together as a buffering assembly 1520 and may be disposed between the movable assembly 1200 and the fixed portion 1100. In some embodiments, the second buffering element 1522, the third buffering element 1523, the fourth buffering element 1524, the fifth buffering element 1525, and the sixth buffering element 1526 may have same or similar structural details to the first buffering element 1521, and it is not repeated again.

In some embodiments, the buffering assembly 1520 may be resilient, such as its Young's modulus may be less than that of the case 1110 and the bottom 1120. Furthermore, when the movable assembly 1200 is at a first position (such as the position when no power is provided to the driving assembly 1400), the buffering assembly 1520 (e.g. the first buffering element 1521) may only contact one of the movable assembly 1200 and the fixed portion 1100. Therefore, the movable assembly 1200 may be prevented from being in direct contact with the fixed portion 1100 when the movable assembly 1200 is moving.

In some embodiments, as shown in FIG. 4A, when viewed along the first height 1921, the movable assembly 1200 (such as the second movable portion 1220) may be polygonal and may include a first side 1241, a second side 1242, a third side 1243, and a fourth side 1244. The first side 1241 is adjacent to the second side 1242 and the fourth side 1244, and the third side 1243 is adjacent to the second side 1242 and the fourth side 1244. In some embodiments, the first buffering element 1521 may be disposed on the first side 1241, the second buffering element 1522 and the third buffering element 1523 may be disposed on the second side 1242, the fourth buffering element 1524 and the fifth buffering element 1525 may be disposed on the third side 1243, and the sixth buffering element 1526 may be disposed on the fourth side 1244. Therefore, the sides of the second movable portion 1220 may be protected to prevent the second movable portion 1220 from being collide to the fixed portion 1100 when the second movable portion 1220 is moving.

In some embodiments, as shown in FIG. 4B and FIG. 4C, a distance between the first buffering element 1521 and the bottom surface 1128 of the bottom 1120 may be different from other buffering elements. For example, a first distance 1971 is between the first buffering element 1521 and the bottom surface 1128 of the bottom 1120, and other buffering elements (such as the second buffering element 1522) may have a second distance 1972 to the bottom surface 1128 of the bottom 1120, and the first distance 1971 and the second distance 1972 are different. For example, the first distance 1971 may be less than the second distance 1972 to allow the first circuit element 1310 being disposed on the first side 1241.

In some embodiments, as shown in FIG. 3A and FIG. 4A, the optical element driving mechanism 1000 may further include a guiding assembly 1430 disposed between the first movable portion 1210 and the second movable portion 1220 to guide the moving direction of the first movable portion 1210 relative to the second movable portion 1220. For example, the guiding assembly 1430 may include a first guiding element 1431 and a second guiding element 1432 that are column-shaped and extending along the first axis 1911. In some embodiments, the first guiding element 1431 and the second guiding element 1432 may arrange along second axis 1912. Therefore, the first movable portion 1210 may move relative to the second movable portion 1220 along the first axis 1911 to achieve auto focus.

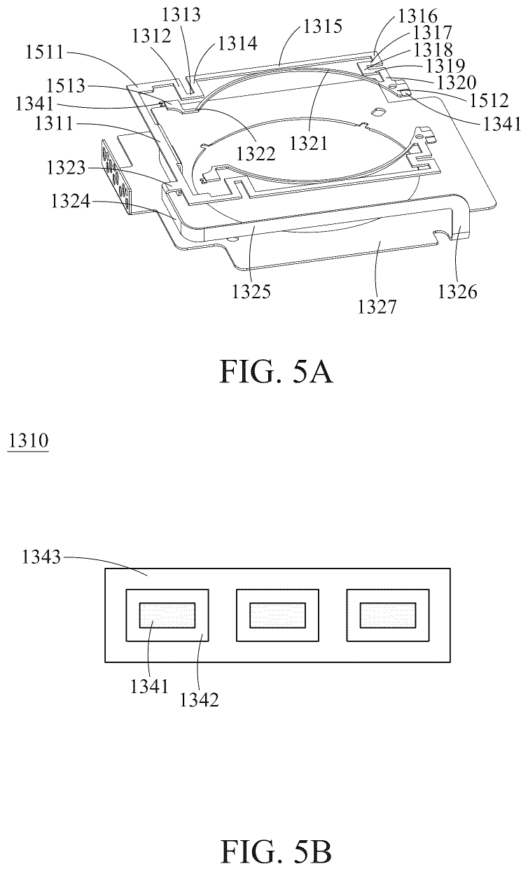

FIG. 5A is a schematic view of the first circuit element 1310. As shown in FIG. 4A to FIG. 4D and FIG. 5A, the first circuit element 1310 may include a first segment 1311, a second segment 1312, a third segment 1313, a fourth segment 1314, a fifth segment 1315, a sixth segment 1316, a seventh segment 1317, an eighth segment 1318, a ninth segment 1319, a tenth segment 1320, an eleventh segment 1321, a twelfth segment 1322, a thirteenth segment 1323, a fourteenth segment 1324, a fifteenth segment 1325, a sixteenth segment 1326, a substrate 1327, a first connecting portion 1511, a second connecting portion 1512, and a third connecting portion 1513.

In some embodiments, the first circuit element 1310 may be affixed on the second movable portion 1220 through the first connecting portion 1511, and may be affixed on the first movable portion 1210 through the second connecting portion 1512. The first segment 1311 and the second segment 1312 may connect to the first connecting portion 1511. In some embodiments, the first segment 1311 and the second segment 1312 may extend in the direction that the third axis 1913 extends, and the first connecting portion 1511 may extend in the direction that the second axis 1912 extends. In other words. The first segment 1311 and the second segment 1312 extend in a direction different from the direction that the first connecting portion 1511 extends.

In some embodiments, the third segment 1313 connects to the second segment 1312, the fourth segment 1314 connects to the third segment 1313, the fifth segment 1315 connects to the fourth segment 1314, the sixth segment 1316 connects to the fifth segment 1315, the seventh segment 1317 connects to the sixth segment 1316, the eighth segment 1318 connects to the seventh segment 1317, the ninth segment 1319 connects to the eighth segment 1318, the tenth segment 1320 connects to the ninth segment 1319 and the second connecting portion 1512, the eleventh segment 1321 connects to the second connecting portion 1512, the twelfth segment 1322 connects to the first buffering element 1521, the thirteenth segment 1323 connects to the first segment 1311, the fourteenth segment 1324 connects to the thirteenth segment 1323, the fifteenth segment 1325 connects to the fourteenth segment 1324, the sixteenth segment 1326 connects to the fifteenth segment 1325, and the substrate 1327 connects to the sixteenth segment 1326 and may be affixed on the bottom 1120.

In some embodiments, the first circuit element 1310 may be bent to allow the first circuit element 1310 moving relative to the second movable portion 1220 and allow the second movable portion 1220 moving relative to the fixed portion 1100. In some embodiments, the second segment 1312 and the third segment 1313 extend in different directions, the third segment 1313 and the fourth segment 1314 extend in different directions, the fourth segment 1314 and the fifth segment 1315 extend in different directions, the fifth segment 1315 and the sixth segment 1316 extend in different directions, the sixth segment 1316 and the seventh segment 1317 extend in different directions, the seventh segment 1317 and the eighth segment 1318 extend in different directions, the eighth segment 1318 and the ninth segment 1319 extend in different directions, and the ninth segment 1319 and the tenth segment 1320 extend in different directions. For example, the third segment 1313, the fifth segment 1315, the seventh segment 1317, and the ninth segment 1319 may extend in the second axis 1912, and the fourth segment 1314, the sixth segment 1316, the eighth segment 1318, and the tenth segment 1320 may extend in the third axis 1913. Therefore, the first circuit element 1310 may be bent to increase the flexibility of the first circuit element 1310.

In some embodiments, the eleventh segment 1321 is arc-shaped, the twelfth segment 1322 extends in the second axis 1912, the thirteenth segment 1323 extends in the first height 1921, the fourteenth segment 1324 extends in the third axis 1913, the fifteenth segment 1325 extends in the second axis 1912, the sixteenth segment 1326 extends in the first axis 1911, and a substrate 1927 is between the bottom 1120 and the circuit assembly 1300 and affixed on the bottom 1120 and the second circuit element 1330. In other words, along the first axis 1911, the first circuit element 1310 may be partially disposed between the bottom 1120 and the second circuit element 1330 (such as the substrate 1327) and partially disposed between the movable assembly 1200 and the case 1110 (such as the thirteenth segment 1323, the fourteenth segment 1324, the fifteenth segment 1325, and the sixteenth segment 1326).

In some embodiments, an additional damping element 1630 may be disposed between the first circuit element 1310 and the second movable portion 1220 to movably connect a portion of the first circuit element 1310 and the second movable portion 1220. In some embodiments, as shown in FIG. 4D, the damping element 1630 may be disposed between the second movable portion 1220 and the thirteenth segment 1323, the fourteenth segment 1324, the fifteenth segment 1325, and the sixteenth segment 1326. For example, the damping element 1630 may be disposed on the bent portion of first circuit element 1310 to absorb vibration, so the bent portion of the first circuit element 1310 may be prevented from being damaged. In some embodiments, the material of the damping element 1630 may include resilient element, such as gel.

FIG. 5B is a cross-sectional view of the first circuit element 1310. As shown in FIG. 5B, the first circuit element 1310 may include a plurality of conductive circuits 1341, a plurality of protective layers 1342, and an insulating layer 1343. The protective layer 1342 may cover the conductive circuit 1341, and the plurality of conductive circuits 1341 and the plurality of protective layers 1342 may be disposed in a same insulating layer 1343. The conductive circuit 1341 may include conductive metal, the protective layer 1342 and the insulating layer 1343 may include insulating materials, and the materials of the protective layer 1342 and the insulating layer 1343 may be different. Therefore, electrical signal may be transmitted through the conductive circuit 1341 in the first circuit element 1310.

In some embodiments, as shown in FIG. 4A and FIG. 5A, the conductive circuit 1341 may be exposed from the first circuit element 1310 at the second connecting portion 1512 and the third connecting portion 1513 to allow other elements being electrically connected through the conductive circuit 1341. For example, additional aperture element (not shown), and the aperture element may be electrically connected to the conductive circuit 1341 exposed from the second connecting portion 1512, so the optical element driving mechanism 1000 may interact with other elements. Furthermore, the third connecting portion 1513 may connect to the first coil element 1411 or the second coil element 1412 to provide energy to the first coil element 1411 or the second coil element 1412.

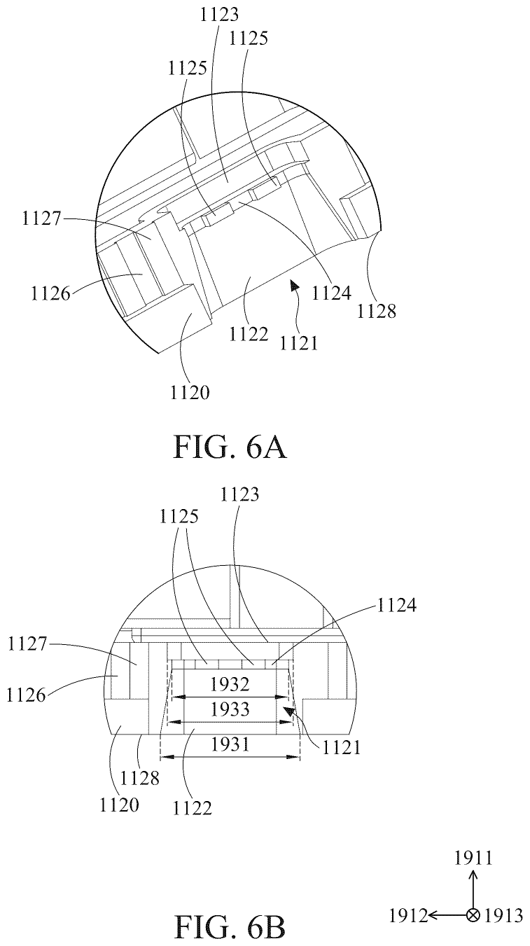

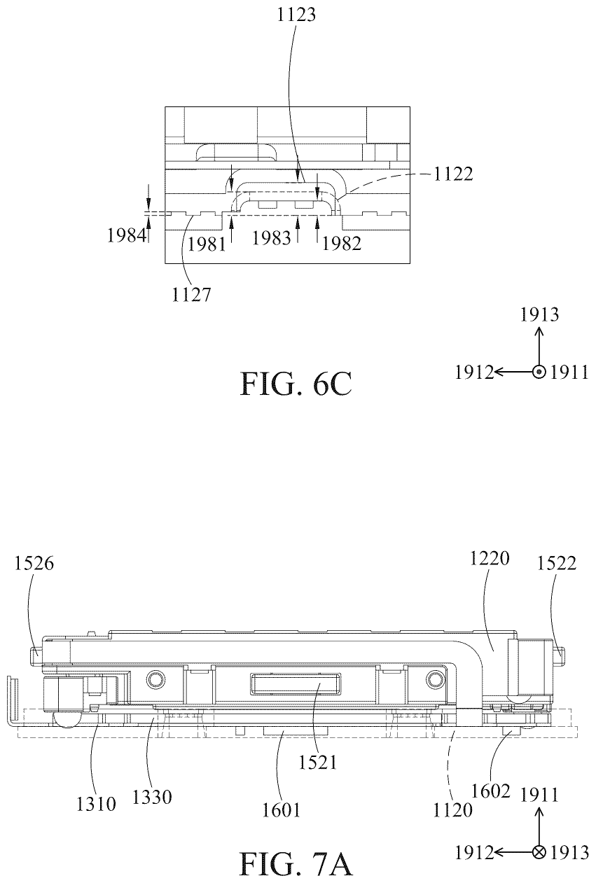

FIG. 6A, FIG. 6B, and FIG. 6C are enlarged views of the bottom 1120 viewed from different directions, wherein FIG. 6C is an enlarged view of the region R2 in FIG. 4A. As shown in FIG. 4C and FIG. 6A to FIG. 6C, the bottom 1120 may include a plurality of recesses 1121 located at an external surface 1127 of the bottom 1120. In some embodiments, the external surface 1127 may be parallel to the first axis 1911. In some embodiments, the recesses 1121 may include a first recess portion 1122, a second recess portion 1123, and a connecting portion 1124. The first recess portion 1122 may connect to the second recess portion 1123 through the connecting portion 1124.

In some embodiments, the first recess portion 1122 may connect to the bottom surface 1128 and may be trapezoidal. For example, the first recess portion 1122 has a first width 1931 at a side connected to the bottom surface 1128 and a second width 1932 at a side connected to the connecting portion 1124, and the first width 1931 and the second width 1932 are different. For example, the first width 1931 may be greater than the second width 1932 in order to make it easier to demold when manufacturing the bottom 1120.

In some embodiments, the connecting portion 1124 may include a third width 1933, and the third width 1933 may be different from the first width 1931 and the second width 1932. For example, the first width 1931 may be greater than the third width 1933, and the second width 1932 may be less than the third width 1933. In some embodiments, circuit may be embedded in the bottom 1120, and a circuit terminal 1125 of the circuit may be exposed from the bottom 1120, such as exposed from the bottom 1120 at the connecting portion 1124. In some embodiments, a plurality of circuit terminals 1125 may be exposed at an identical connecting portion 1124.

In some embodiments, the trench 1126 may further include a plurality of trenches 1126 recessed from the external surface 1127 and extending along the first axis 1911. Therefore, the surface area of the bottom 1120 may be increased to increase the adhesion strength between the case 1110 and the bottom 1120 when bonded by an adhesive element 1111. For example, the adhesive element 1111 may be disposed between the case 1110 and the bottom 1120 and in the trenches 1126. In some embodiments, the recess 1121 may be located between the plurality of trenches 1126.

In some embodiments, as shown in FIG. 6C, when calculated from the external surface 1127, the first recess portion 1122 may have a first depth 1981, the connecting portion 1124 may have a second depth 1982, the second recess portion 1123 may have a third depth 1983, the trench 1126 may have a fourth depth 1984, and the first depth 1981, the second depth 1982, the third depth 1983, and the fourth depth 1984 may be different. For example, the first depth 1981 may be greater than the second depth 1982 and the fourth depth 1984 and less than the third depth 1983. The second depth 1982 may be less than the third depth 1983 and greater than the fourth depth 1984. The third depth 1983 may be greater than the fourth depth 1984.

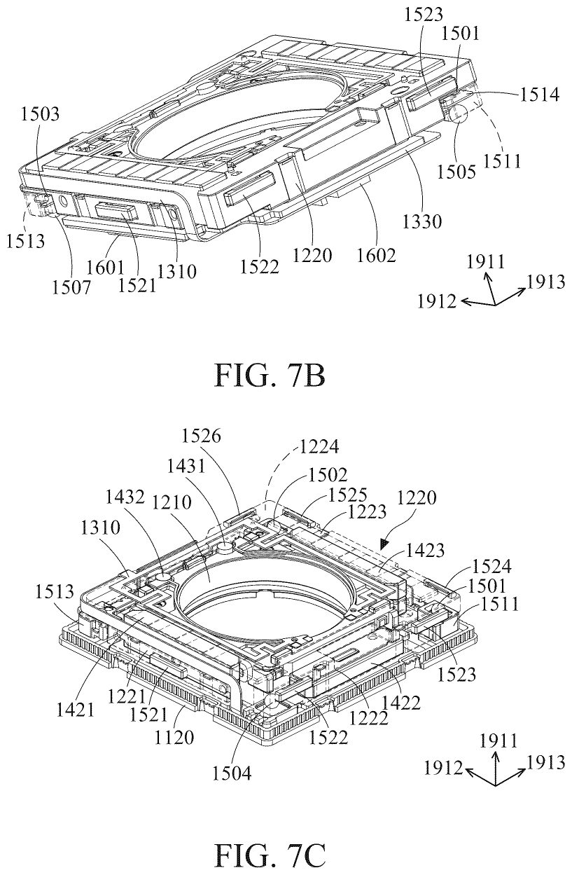

FIG. 7A, FIG. 7B, and FIG. 7C are schematic views of some elements of the optical element driving mechanism 1000. As shown in FIG. 2D, FIG. 2E, and FIG. 7A to FIG. 7C, the connecting assembly 1500 may include a first connecting element 1501, a second connecting element 1502, a third connecting element 1503, a fourth connecting element 1504, a fifth connecting element 1505, a sixth connecting element 1506, a seventh connecting element 1507, a first connecting portion 1511, a second connecting portion 1512, a third connecting portion 1513, and a fourth strengthen element 1514.

In some embodiments, the first connecting element 1501, the second connecting element 1502, the third connecting element 1503, and the fourth connecting element 1504 may be disposed on the second movable portion 1220, and the fifth connecting element 1505, the sixth connecting element 1506, and the seventh connecting element 1507 may be disposed on the bottom 1120. In some embodiments, the first connecting portion 1511, the second connecting portion 1512, and the third connecting portion 1513 may connect to each other through the fourth strengthen element 1514 and may be disposed between the bottom 1120 and the second movable portion 1220. In some embodiments, the first connecting element 1501 and the fifth connecting element 1505 may be disposed on opposite sides of the first connecting portion 1511, the second connecting element 1502 and the sixth connecting element 1506 may be disposed on opposite sides of the second connecting portion 1512, and the third connecting element 1503 and the seventh connecting element 1507 may be disposed on opposite sides of the third connecting portion 1513. The fourth connecting element 1504 may be disposed in an accommodating space 1950 between the bottom 1120 and the second movable portion 1220.

In some embodiments, as shown in FIG. 2D and FIG. 2E, the first connecting element 1501, the second connecting element 1502, and the third connecting element 1503 may be disposed on a first virtual plane 1941, and a normal vector of the first virtual plane 1941 may be parallel to the main axis 1900 (or to the first axis 1911). For example, the first virtual plane 1941 may pass through the first connecting element 1501, the second connecting element 1502, and the third connecting element 1503. That is, portions of the first connecting element 1501, the second connecting element 1502, and the third connecting element 1503 are located at a side of the first virtual plane 1941, and other portions are located at another side of the first virtual plane 1941.

In some embodiments, as shown in FIG. 2D and FIG. 2E, the fifth connecting element 1505, the sixth connecting element 1506, and the seventh connecting element 1507 may be disposed on the second virtual plane 1942, and a normal vector of the second virtual plane 1942 may be parallel to the main axis 1900 (or to the first axis 1911). For example, the second virtual plane 1942 may pass through centers of the fifth connecting element 1505, the sixth connecting element 1506, and the seventh connecting element 1507. Furthermore, the first virtual plane 1941 and the second virtual plane 1942 may be parallel.

In some embodiments, the fourth connecting element 1504 is not located on the first virtual plane 1941 and the second virtual plane 1942, such as the fourth connecting element 1504 may be located between the first virtual plane 1941 and the second virtual plane 1942, and the first virtual plane 1941 and the second virtual plane 1942 do not pass through the fourth connecting element 1504. For example, the first virtual plane 1941 and the second virtual plane 1942 may have distances greater than zero to the fourth connecting element 1504. In some embodiments, in the first axis 1911, the fourth connecting element 1504 may have a first height 1921, the accommodating space 1950 may have a second height 1922, and the first height 1921 is less than the second height 1922. In other words, the fourth connecting element 1504 may not be used for supporting the second movable portion 1220 and the bottom 1120 in common situations, but the fourth connecting element 1504 may be a stopper when the second movable portion 1220 is tilted to prevent the second movable portion 1220 from being damaged.

In some embodiments, the first connecting element 1501, the second connecting element 1502, the third connecting element 1503, the fourth connecting element 1504, the fifth connecting element 1505, the sixth connecting element 1506, and the seventh connecting element 1507 may be spherical, and their material may include, for example, ceramic. Therefore, they may roll when the second movable portion 1220 moves relative to the bottom 1120 to reduce the friction between the second movable portion 1220 and the bottom 1120, so the second movable portion 1220 is easier to be moved. It should be noted that since a plane can be defined by three points, the first virtual plane 1941 is defined by the first connecting element 1501, the second connecting element 1502, and the third connecting element 1503, and the second virtual plane 1942 is defined by the fifth connecting element 1505, the sixth connecting element 1506, and the seventh connecting element 1507. As a result, the main axis 1900 of the optical element driving mechanism 1000 may be prevented from being tilted during operation to increase its optical performance.

In some embodiments, as shown in FIG. 2A, FIG. 7A, and FIG. 7B, the optical element driving mechanism 1000 may include a sensor 1601, a sensor 1602, a sensor 1603, and a sensing magnetic element 1610. The sensor 1601 and the sensor 1602 may be disposed on the bottom 1120, the sensor 1603 may be disposed on the second movable portion 1220, and the sensing magnetic element 1610 may be disposed on the first movable portion 1210. In some embodiments, the sensor 1601 and the sensor 1602 may respectively correspond to the first magnetic element 1421 and the second magnetic element 1422, such as they may partially overlap each other along the first axis 1911. The sensor 1603 may correspond to the sensing magnetic element 1610, such as they may partially overlap each other along the third axis 1913.

In some embodiments, the sensing magnetic element 1610 may include a Hall sensor, a magnetoresistance effect sensor (MR sensor), a giant magnetoresistance effect sensor (GMR sensor), a tunneling magnetoresistance effect sensor (TMR sensor), or a fluxgate sensor. Therefore, positions of the first movable portion 1210 and the second movable portion 1220 during moving may be detected to precisely control the first movable portion 1210 and the second movable portion 1220.

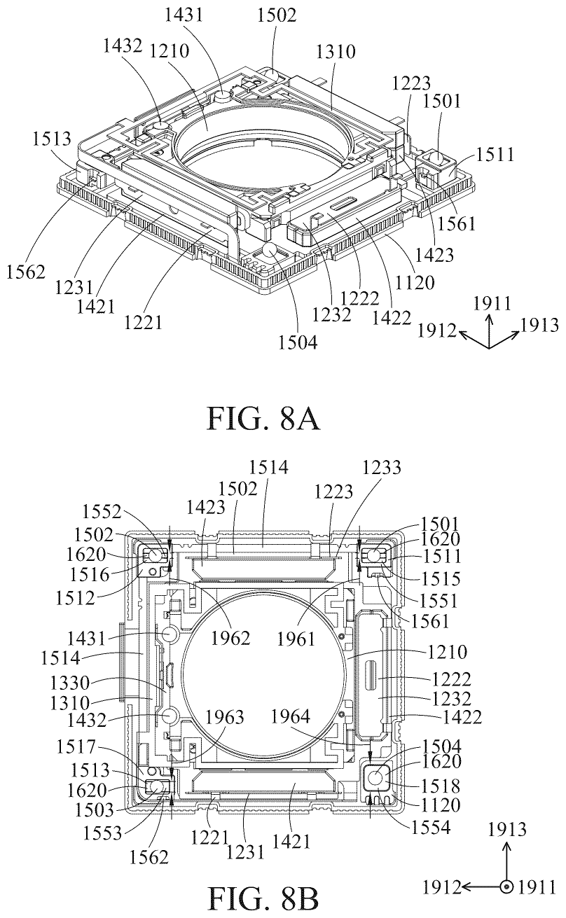

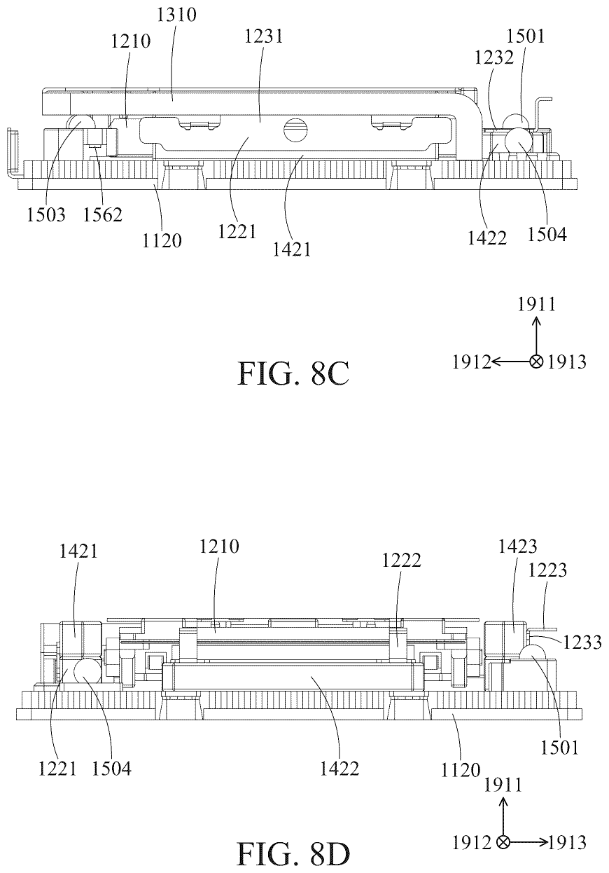

FIG. 8A, FIG. 8B, FIG. 8C, and FIG. 8D are schematic views of some elements of the optical element driving mechanism 1000 viewed in different directions, wherein the second movable portion 1220 is further omitted. In some embodiments, as shown in FIG. 8B, the fourth strengthen element 1514 may be at least partially exposed from the first connecting portion 1511, the second connecting portion 1512, and the third connecting portion 1513, and the material of the fourth strengthen element 1514 may include non-magnetic permeable metal. As a result, the first connecting portion 1511, the second connecting portion 1512, and the third connecting portion 1513 may connect to each other through the fourth strengthen element 1514. In some embodiments, as shown in FIG. 2D, FIG. 2E, and FIG. 8B, the fourth strengthen element 1514 may at least partially overlap the first connecting element 1501, the second connecting element 1502, the third connecting element 1503, the fifth connecting element 1505, the sixth connecting element 1506, the seventh connecting element 1507, and the second movable portion 1220, and the fourth strengthen element 1514 does not overlap the fourth connecting element 1504.

Moreover, the fourth strengthen element 1514 may include a first end 1561 and a second end 1562, wherein the first end 1561 may be disposed on the first connecting portion 1511 and at least partially exposed from the first connecting portion 1511, and the second end 1562 may be disposed on the third connecting portion 1513 and at least partially exposed from the third connecting portion 1513. In some embodiments, the first end 1561 and the second end 1562 may extend in an identical direction, such as a direction parallel to the second axis 1912.

In some embodiments, as shown in FIG. 2D, FIG. 2E, and FIG. 8B, the first connecting portion 1511 may include a first recessed portion 1515 and a fifth recessed portion 1541, the second connecting portion 1512 may include a second recessed portion 1516, a sixth recessed portion 1542, the third connecting portion 1513 may include a third recessed portion 1517 and a seventh recessed portion 1543, and the bottom 1120 may include a fourth recessed portion 1518. The first connecting element 1501 may be disposed in the first recessed portion 1515, the second connecting element 1502 may be disposed in the second recessed portion 1516, the third connecting element 1503 may be disposed in the third recessed portion 1517, the fourth connecting element 1504 may be disposed in the fourth recessed portion 15187, the fifth connecting element 1505 may be disposed in the fifth recessed portion 1541, the sixth connecting element 1506 may be disposed in the sixth recessed portion 1542, and the seventh connecting element 1507 may be disposed in the seventh recessed portion 1543.

In some embodiments, in the direction that the first axis 1911 extends, the first recessed portion 1515 and the fifth recessed portion 1541 may at least partially overlap each other, the second recessed portion 1516 and the sixth recessed portion 1542 may at least partially overlap each other, and the third recessed portion 1517 and the seventh recessed portion 1543 may at least partially overlap each other. In other words, in the direction that the first axis 1911 extends, the first connecting element 1501 and the fifth connecting element 1505 may at least partially overlap each other, the second connecting element 1502 and the sixth connecting element 1506 may at least partially overlap each other, and the third connecting element 1503 and the seventh connecting element 1507 may at least partially overlap each other to reduce sizes in other directions to achieve miniaturization.

In some embodiments, the first recessed portion 1515 include a first recessed surface 1551, the second recessed portion 1516 include a second recessed surface 1552, the third recessed portion 1517 include a third recessed surface 1553, the fourth recessed portion 1518 include a fourth recessed surface 1554, the fifth recessed portion 1541 include a fifth recessed surface 1555, the sixth recessed portion 1542 include a sixth recessed surface 1556, and the seventh recessed portion 1543 include a seventh recessed surface 1557, The first recessed surface 1551, the second recessed surface 1552, the third recessed surface 1553, and the fourth recessed surface 1554 may face an identical direction, and the first recessed surface 1551, the second recessed surface 1552, the third recessed surface 1553, and the fourth recessed surface 1554 may face a direction opposite from a direction that the fifth recessed surface 1555, the sixth recessed surface 1556, and the seventh recessed surface 1557. For example, the first recessed surface 1551, the second recessed surface 1552, the third recessed surface 1553, and the fourth recessed surface 1554 may face away from the bottom 1120, the fifth recessed surface 1555, the sixth recessed surface 1556, and the seventh recessed surface 1557 may face the bottom 1120, and their normal vectors may be parallel to the first axis 1911.

In some embodiments, as shown in FIG. 8B, when viewed along the first axis 1911, the second recessed portion 1516 and the third recessed portion 1517 are arranged in a direction parallel to the third axis 1913, and the first recessed portion 1515 and the second recessed portion 1516 are arranged along a direction parallel to the second axis 1912. In some embodiments, as shown in FIG. 8B, in the direction that the second axis 1912 extends, the first recessed surface 1551 has a first size 1961, the second recessed surface 1552 has a second size 1962, the third recessed surface 1553 has aa third size 1963, and the fourth recessed surface 1554 has a fourth size 1964. The first size 1961 and the second size 1962 may be identical, the first size 1961 may be different from the third size 1963 and the fourth size 1964, and the third size 1963 and the fourth size 1964 may be different from each other. For example, the first size 1961 may be less than the third size 1963, and the third size 1963 may be less than the fourth size 1964. Therefore, tolerances that prevent the optical element driving mechanism 1000 from being assembled may be avoided.

In some embodiments, a lubricant 1620 (such as lubricant) may be disposed on the first recessed portion 1515, the second recessed portion 1516, the third recessed portion 1517, the fourth recessed portion 1518, the fifth recessed portion 1541, the sixth recessed portion 1542, and the seventh recessed portion 1543 to further decrease the frictions between the connecting assembly 1500, the second movable portion 1220, and the bottom 1120.

In some embodiments, additional strengthen element may be added in the second movable portion 1220 to increase the mechanical strength of the second movable portion 1220, and the strengthen element may be magnetic permeable. For example, as shown in FIG. 7C and FIG. 8A to FIG. 8D, the second movable portion 1220 may include a main body 1224, and a first strengthen element 1221, a second strengthen element 1222, and a third strengthen element 1223 may be included in the main body 1224. In some embodiments, the first strengthen element 1221, the second strengthen element 1222, and the third strengthen element 1223 may be separated from each other and may include magnetic permeable metal. It should be noted that in some embodiments, the first strengthen element 1221, the second strengthen element 1222, and the third strengthen element 1223 may be partially exposed from the main body 1224.

In some embodiments, as shown in FIG. 8A and FIG. 8B, the first strengthen element 1221 may include a first surface 1231, the second strengthen element 1222 may include a second surface 1232, and the third strengthen element 1223 may include a third surface 1233. The first surface 1231, the second surface 1232, and the third surface 1233 may face away from the driving assembly 1400. For example, the first surface 1231 may face away from the first magnetic element 1421, the second surface 1232 may face away from the second magnetic element 1422, the third surface 1233 may face away from the third magnetic element 1423, and the first surface 1231, the second surface 1232, and the third surface 1233 may face different directions. For example, the first surface 1231 and the third surface 1233 may have normal vectors parallel to the second axis 1912 and face opposite directions. The normal vector of the twelfth segment 1322 may be parallel to the first axis 1911. Therefore, the mechanical strength of the second movable portion 1220 may be increased, and t directions of the magnetic field lines of the magnetic assembly 1420 may be concentrated to increase the performance of the optical element driving mechanism 1000.

In summary, an optical element driving mechanism is provided, which includes a movable assembly, a fixed portion, and a driving assembly. The movable assembly is used for connecting an optical element. The movable assembly is movable relative to the fixed portion. The driving assembly is used for driving the movable assembly to move relative to the fixed portion. Therefore, the moving direction of the movable portion relative to the fixed portion can be further stabilized to achieve better filming performance.

The relative positions and size relationship of the elements in the present disclosure may allow the driving mechanism achieving miniaturization in specific directions or for the entire mechanism. Moreover, different optical modules may be combined with the driving mechanism to further enhance optical quality, such as the quality of photographing or accuracy of depth detection. Therefore, the optical modules may be further utilized to achieve multiple anti-vibration systems, so image stabilization may be significantly improved.

Although embodiments of the present disclosure and their advantages already have been described in detail, it should be understood that various changes, substitutions and alterations may be made herein without departing from the spirit and the scope of the disclosure as defined by the appended claims. Moreover, the scope of the present application is not intended to be limited to the particular embodiments of the process, machine, manufacture, and composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are also intended to include within their scope of such processes, machines, manufacture, and compositions of matter, means, methods, or steps. In addition, each claim herein constitutes a separate embodiment, and the combination of various claims and embodiments are also within the scope of the disclosure.

What is claimed is:

1. An optical element driving mechanism, comprising:
a movable assembly used for connecting an optical element;
a fixed portion, wherein the movable assembly is movable relative to the fixed portion; and
a driving assembly used for driving the movable assembly to move relative to the fixed portion.

2. The optical element driving mechanism as claimed in claim 1, wherein:
the movable assembly comprises a first movable portion and a second movable portion, wherein the second movable portion is movably connected to the fixed portion and the first movable portion;
the fixed portion comprises a case and a bottom, and the movable assembly is disposed between the case and the bottom;
the case and the bottom are arranged along a main axis;
the main axis extends in a direction parallel to a first axis.

3. The optical element driving mechanism as claimed in claim 2, further comprising a connecting assembly disposed between the bottom and the second movable portion used for connecting the bottom and the second movable portion;
wherein the connecting assembly comprises:
a first connecting element disposed on the second movable portion;
a second connecting element disposed on the second movable portion;
a third connecting element disposed on the second movable portion; and
a fourth connecting element disposed in an accommodating space between the second movable portion and the bottom.

4. The optical element driving mechanism as claimed in claim 3, wherein:
the first connecting element, the second connecting element, and the third connecting element are located on a first virtual plane;
the fourth connecting element is not located on the first virtual plane;
a normal vector of the first virtual plane is parallel to the first axis;
materials of the first connecting element, the second connecting element, the third connecting element, and the fourth connecting element comprise ceramic;
the fourth connecting element has a first height in the first axis;
the accommodating space has a second height in the first axis;
the first height is less than the second height.

5. The optical element driving mechanism as claimed in claim 4, wherein the second movable portion comprises:
a main body;
a first strengthen element disposed in the main body;
a second strengthen element disposed in the main body; and
a third strengthen element disposed in the main body;
wherein:
the first strengthen element, the second strengthen element, and the third strengthen element are separated from each other;
materials of the first strengthen element, the second strengthen element, and the third strengthen element comprises metal;
the first strengthen element, the second strengthen element, and the third strengthen element are magnetic permeable.

6. The optical element driving mechanism as claimed in claim 5, wherein:
the first strengthen element is at least partially exposed from the main body;
the second strengthen element is at least partially exposed from the main body;
the third strengthen element is at least partially exposed from the main body;
the first strengthen element comprises a first surface facing away from the driving assembly;
the second strengthen element comprises a second surface facing away from the driving assembly;
the third strengthen element comprises a third surface facing away from the driving assembly;
the first surface, the second surface, and the third surface face different directions;
a normal vector of the second surface is parallel to the first axis.

7. The optical element driving mechanism as claimed in claim 6, wherein:
the connecting assembly further comprises a first connecting portion, a second connecting portion, and a third connecting portion;
the first connecting element is disposed between the first connecting portion and the second movable portion;
the second connecting element is disposed between the second connecting portion and the second movable portion;
the third connecting element is disposed between the third connecting portion and the second movable portion;
the fourth connecting element is in direct contact with the bottom and the second movable portion.

8. The optical element driving mechanism as claimed in claim 7, wherein:
the connecting assembly further comprises a fourth strengthen element;
the fourth strengthen element passes through the first connecting portion, the second connecting portion, and the third connecting portion;
the fourth strengthen element is at least partially exposed from the first connecting portion, the second connecting portion, and the third connecting portion;
material of the fourth strengthen element comprises non-magnetic permeable metal.

9. The optical element driving mechanism as claimed in claim 8, wherein:
the first connecting portion comprises a first recessed portion;
the second connecting portion comprises a second recessed portion;
the third connecting portion comprises a third recessed portion;
the first connecting element is disposed in the first recessed portion;
the second connecting element is disposed in the second recessed portion;
the third connecting element is disposed in the third recessed portion.

10. The optical element driving mechanism as claimed in claim 9, wherein:
the second recessed portion and the third recessed portion are arranged in a direction parallel to a third axis when viewed along the first axis;
the first recessed portion and the second recessed portion are arranged in a direction parallel to a second axis when viewed along the first axis;
the first axis, the second axis, and the third axis extend in different directions.

11. The optical element driving mechanism as claimed in claim 10, wherein:
the bottom comprises a fourth recessed portion;
the first axis and the second axis are perpendicular;
the first axis and the third axis are perpendicular;
the second axis and the third axis are perpendicular;
the connecting assembly further comprises a fifth connecting element, a sixth connecting element, and a seventh connecting element;
the fifth connecting element is disposed between the bottom and the first connecting portion;
the sixth connecting element is disposed between the bottom and the second connecting portion;
the seventh connecting element is disposed between the bottom and the third connecting portion.

12. The optical element driving mechanism as claimed in claim 11, wherein:
the first connecting element and the fifth connecting element at least partially overlap each other in the first axis;
the second connecting element and the sixth connecting element at least partially overlap each other in the first axis;
the third connecting element and the seventh connecting element at least partially overlap each other in the first axis.

13. The optical element driving mechanism as claimed in claim 12, wherein:
the fifth connecting element, the sixth connecting element, and the seventh connecting element are located on a second virtual plane;
the fourth connecting element is located on the fourth recessed portion;
the fourth connecting element is not located on the second virtual plane;
the fourth connecting element is between the first virtual plane and the second virtual plane;
the first virtual plane and the second virtual plane are parallel.

14. The optical element driving mechanism as claimed in claim 13, wherein:
the first connecting portion further comprises a fifth recessed portion;
the second connecting portion further comprises a sixth recessed portion;
the third connecting portion further comprises a seventh recessed portion;
the fifth connecting element is disposed in the fifth recessed portion;
the sixth connecting element is disposed in the sixth recessed portion;
the seventh connecting element is disposed in the seventh recessed portion.

15. The optical element driving mechanism as claimed in claim 14, wherein:
the first recessed portion comprises a first recessed surface;
the second recessed portion comprises a second recessed surface;
the third recessed portion comprises a third recessed surface;
the fourth recessed portion comprises a fourth recessed surface;
the fifth recessed portion comprises a fifth recessed surface;
the sixth recessed portion comprises a sixth recessed surface;
the seventh recessed portion comprises a seventh recessed surface;
the first recessed surface and the fifth recessed surface face opposite directions;
the second recessed surface and the sixth recessed surface face opposite directions;
the third recessed surface and the seventh recessed surface face opposite directions;
the first recessed surface, the second recessed surface, the third recessed surface, and the fourth recessed surface face an identical direction.

16. The optical element driving mechanism as claimed in claim 15, wherein:
the first recessed surface has a first size in the second axis;
the second recessed surface has a second size in the second axis;
the third recessed surface has a third size in the second axis;
the fourth recessed surface has a fourth size in the second axis;
the first size and the second size are different;
the first size and the third size are different;
the first size and the fourth size are different;
the third size and the fourth size are different.

17. The optical element driving mechanism as claimed in claim 16, wherein:
the first size is less than the third size;
the third size is less than the fourth size.

18. The optical element driving mechanism as claimed in claim 17, further comprising a lubricant disposed on the first recessed portion, the second recessed portion, the third recessed portion, the fourth recessed portion, the fifth recessed portion, the sixth recessed portion, and the seventh recessed portion.

19. The optical element driving mechanism as claimed in claim 18, wherein:
the fourth strengthen element and the first connecting element at least partially overlap each other in the first axis;
the fourth strengthen element and the second connecting element at least partially overlap each other in the first axis;
the fourth strengthen element and the third connecting element at least partially overlap each other in the first axis;
the fourth strengthen element and the fourth connecting element do not overlap each other in the first axis;
the fourth strengthen element and the fifth connecting element at least partially overlap each other in the first axis;
the fourth strengthen element and the sixth connecting element at least partially overlap each other in the first axis;
the fourth strengthen element and the seventh connecting element at least partially overlap each other in the first axis;
the fourth strengthen element and the second movable portion at least partially overlap each other in the first axis.

20. The optical element driving mechanism as claimed in claim 19, wherein:
the fourth strengthen element comprises a first end and a second end;
the first end is disposed on the first connecting portion at least partially exposed from the first connecting portion;
the second end is disposed on the third connecting portion at least partially exposed from the third connecting portion;
the first end and the second end extend in an identical direction.
